(19) United States
(12) Patent Application Publication
(10) Pub. No.: US 2016/0294786 A1
(43) Pub. Date: Oct. 6, 2016

(54) Telecommunication System and Method Providing Unified Platform For Services Amongst Clients That Execute Browser and Non-Browser Applications

(71) Applicant: Platcomm Corp., Miami, FL (US)

(72) Inventors: Victor Eliezer Marquez Mendoza, Caracas (VE); David Rafael Luna Gonzalez, Santa Rita (VE); Gabriel Gonzalez Morantes, Caracas (VE); Victor Eduardo Medina Malpica, Valencia (VE)

(73) Assignee: Platcomm Corp., Miami, FL (US)

(21) Appl. No.: 15/090,307

(22) Filed: Apr. 4, 2016

Related U.S. Application Data
(60) Provisional application No. 62/217,846, filed on Sep. 12, 2015.
(60) Provisional application No. 62/142,349, filed on Apr. 2, 2015.

(51) Int. Cl. H04L 29/06; H04W 12/08; H04L 12/58; H04W 12/06; H04L 29/08; H04W 4/14

(52) U.S. Cl. CPC H04L 63/0428; H04L 67/02; H04L 65/1006; H04L 65/1053; H04W 4/14; H04L 51/36; H04L 63/08; H04L 63/10; H04W 12/06; H04W 12/08

(57) ABSTRACT

A telecommunication network comprises one or more servers. The one or more servers are configured to connect to a first client device associated with a first user. The first client device executes a web browser application to enable the first user to access telecommunication services using a real-time communication protocol. The web browser application comprises a telecommunication application that uses Hypertext Transfer Protocol (HTTP) to transmit and receive the first user's authentication information. The one or more servers are further configured to connect a second client device associated with a second user. The second client device executes a non-browser application to enable the second user to access the telecommunication resources using an Internet telephony protocol. A web browser application is a telecommunication application that uses HTTP protocol for initiating a session and a non-browser application is a telecommunication application that uses Session Initiation Protocol (SIP) protocol for initiating a session. The non-browser application uses the SIP to forward and receive the second user's authentication information. The one or more servers are configured to authorize the web browser application to access the telecommunication services using HTTP and authorize the non-browser application to access the telecommunication services using SIP. The one or more servers are configured to transport media to the first client device after authorizing access the telecommunication services using HTTP and transport media to the second client device after authorizing access the telecommunication services using SIP.

### FIELD OF THE INVENTION

The present invention generally relates to telecommunication services and more particularly to delivering integrated services to client devices that execute browser and non-browser telecommunication applications.

### BACKGROUND OF THE INVENTION

It is known to provide a combination of telecommunication products and services as solutions over the Internet. These services can be used with multiple devices for a specific products development within different industries. Software has been developed that combines services and tailored solutions for enterprises and carriers globally. A telecommunications service is a service provided by a telecommunications provider, or a specified set of user-information transfer capabilities provided to a group of users by a telecommunications system. Examples of telecommunication services include voice, data, video, chat, teleconferencing or any other form of service involving media. As herein defined, media comprises collective communication outlets or tools that are used to store and deliver information or data, including text, voice, graphics, video or multimedia content.

Public and private networks have been used to provide a variety of services. The Hypertext Transfer Protocol (HTTP) is an application protocol for distributed, collaborative, hypermedia information systems. HTTP is the foundation of data communication for the World Wide Web.

WebRTC (Web Real-Time Communication) is known as an API definition drafted by the World Wide Web Consortium (W3C) that supports browser-to-browser applications for voice calling, video chat, and P2P file sharing without the need of either internal or external plugins. WebRTC enables various types of real time communication such as audio, video and text between users by utilizing the browser. WebRTC is used for services that provide data, voice, content, conferencing communication, screen sharing services, collaboration applications, conferencing collaboration, streaming services, live streaming, consultancy services, switching and media integration, audio video coding, media server applications, SaaS applications, conferencing, chat, and video services, SMS based applications, point to point audio/video/data in mobile applications, video, audio, data interactivity and messaging.

For example, Apidaze (http://www.apidaze.io) is a WebRTC platform as a service provider that offers SMS, Audio, video, voice, call center and siptrunk. Apizee offers video, chat and specialized solutions based in WebRTC for corporations. Others companies offering products and services on web-based platforms are Barc, Broadsoft, 1Click, Communigate, Crosspeer, Daiton, Dialogic, Digium, Doubango, Drum, Easyrtc, Estos, Eudata, Flashfoner, Frozenmountain, Gendband, Holla, Hookflash, Nexmo, Voiceelements, Jitsi, Junghanns, Kurento, Lynckia, Matrix, Meteecho, Nativip, Ngmsvid, Onsip, Openclove, Palava, Peerjs, Plivo, Pubnub, Quobis, Requestec, Sitofono, Sigthcall, Sinch, Solaiemes, Temasys, Tenhands, Tokbo, Tropo, Twilio, Video roaming, Vline, Xirsys, Zingaya, and MayDay.

Websocket protocol is used to provide full-duplex communication channels over a single TCP connection for bidirectional and full-duplex communications over channels unique socket TCP protocol. The SIP is used for signaling and controlling multimedia communication sessions, such as Internet telephony for voice and video calls, as well as instant messaging over Internet Protocol (IP) networks.

Private Branch Exchange (PBX) is an example of a private network that can be used for voice and data services. Asterix software (in http://www.asterisk.org/) offers a virtual PBX service that can be configured and managed remotely, extending the regular use of physical PBX. Asterix is an Open Source software that offers the chance to create a software based virtual PBX. This solution is commonly known but its use is limited to a certain number of users and not scalable enough to build a cloud solution.

Currently, small business and corporations need to dedicate large amounts of capital to deploy communications platforms with global reach. Additionally, in order to get the appropriate services in all locations, plus the logistics problems associated to global support, in-house specialized support is necessary and increases human resources expenses.

Thus, there exists a need to offer an easy, reachable and faster way to improve communications between people (employees, customers and end users) and corporations, reducing the investments required to build an integrated communication solution.

### SUMMARY OF THE INVENTION

Briefly, according to the present invention, a telecommunication network comprises one or more servers. The one or more servers are configured to connect to a first client device associated with a first user. The first client device executes a web browser application to enable the first user to access telecommunication services using a real-time communication protocol. The web browser application comprises a telecommunication application that uses Hypertext Transfer Protocol (HTTP) to transmit and receive the first user's authentication information. The one or more servers are further configured to connect a second client device associated with a second user. The second client device executes a non-browser application to enable the second user to access the telecommunication resources using an Internet telephony protocol. A web browser application is a telecommunication application that uses HTTP protocol for initiating a session and a non-browser application is a telecommunication application that uses Session Initiation Protocol (SIP) protocol for initiating a session. The non-browser application uses the SIP to forward and receive the second user's authentication information. The one or more servers are configured to authorize the web browser application to access the telecommunication services using HTTP and authorize the non-browser application to access the telecommunication services using SIP. The one or more servers are configured to transport media to the first client device after authorizing access the telecommunication services using HTTP and transport media to the second client device after authorizing access the telecommunication services using SIP.

### BRIEF DESCRIPTION OF THE DRAWINGS

FIG. 1 shows a block diagram of various network components that implement a telecommunication network according to the invention.

FIG. 2 shows a block diagram of a Software-as-a-Service (SaaS) platform offering services embodying various aspects of the present invention.

FIG. 3 shows a flow diagram for the Client Access Layer of FIG. 1.

FIG. 4 shows a block diagram of Client Transport Security Layer.

FIG. 5 shows a flow diagram Client Transport Security Layer.

FIG. 6 shows a block diagram of the Frontend Services Layer.

FIG. 7 shows a flow diagram of the Frontend Services Layer.

FIG. 8 shows a block diagram of the Communications Services Layer.

FIG. 9 shows a flow diagram of the Communications Services Layer.

FIG. 10 shows a block diagram of the Configuration Services Layer & Configuration Console.

FIG. 11 shows a flow diagram of the Configuration Services Layer & Configuration Console.

FIG. 12 shows a block diagram of the Database & Cache Services.

FIG. 13 shows a flow diagram of the Database & Cache Services.

FIG. 14 is a flow diagram of a user making an audio or video call over a web browser app or a non-browser mobile phone app.

FIG. 15 is a block diagram of chat service according to on aspect of the invention.

FIG. 16 is a block diagram of a user chat without Internet connection.

FIG. 17 is a block diagram of encryption and security processes in a call.

### DETAILED DESCRIPTION OF THE INVENTION

The present invention is embodied in a telecommunication network that permits offering solutions directed to global communications, corporate communications, customer support, online sales, team collaboration, global integration, online marketing, online surveys, social media contact, and third party software integration. In one example, the network facilitates collaboration between employees of a corporation (globally or locally) and also offers the chance to use each solution in a separate way to build a specific service for each user. For instance, a chat service can be offered to an e-commerce company to deliver online customer support and the chat may also be integrated with video calls and global SMS for a different company on the same platform.

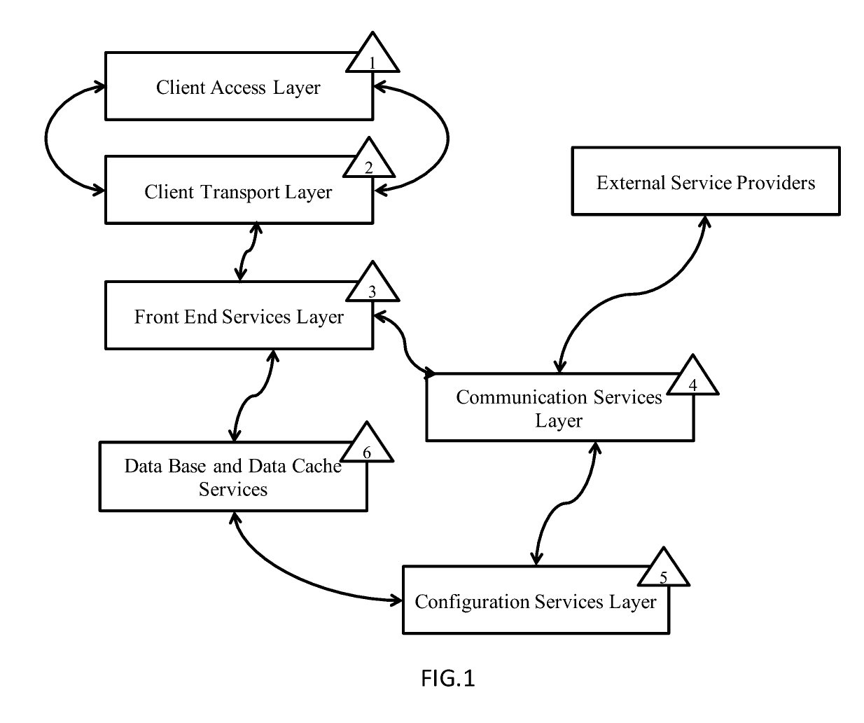

FIG. 1 shows a block diagram of various network components including the Client Access Layer (1), the Client Transport Security layer (2), the Frontend Services Layer (3), the Communication Services Layer (4), and the Configuration Service Layer & Configuration Console (5), Database/cache (6). The telecommunication network shown in FIG. 1 comprises one or more servers configured to provide a unified platform that combines web real-time communication protocol (WebRTC) and Internet telephony protocol, such as VoIP, for connecting different types of client devices associated with users who are grouped by the type of client devices used.

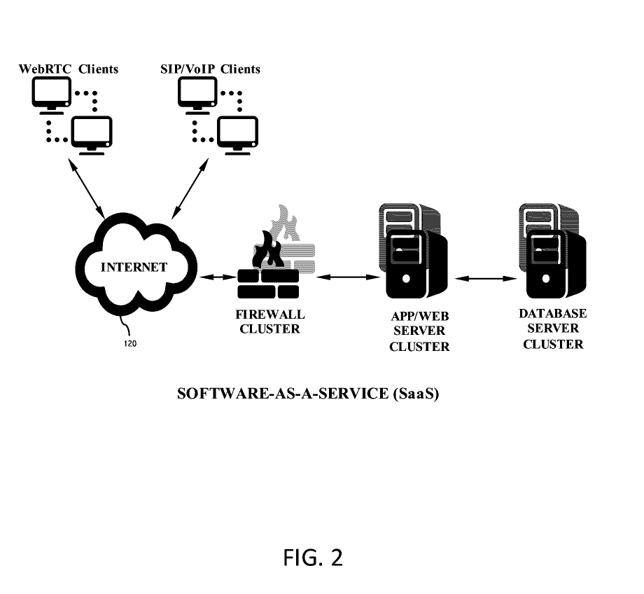

FIG. 2 shows a block diagram of a Software-as-a-Service (SaaS) platform offering services embodying various aspects of the present invention. SaaS is a software licensing and delivery model in which software is licensed on a subscription basis and is hosted centrally or distributed. The SaaS can offer a wide variety of services to subscribers including, but not limited to, health, financial, cyber-security, industrial, transportation, manufacturing, construction services. The SaaS platform comprises an Application/Web Server Cluster of one or more servers, which communicates with a Database Server Cluster of one or more databases. The SaaS platform can be used to provide application services offered to multiple service subscribers. For example, a first and a second service subscriber can each offer independent application services to individuals or participants in an institution or organization over the Internet via a firewall cluster of one or more firewalls. One such SaaS can be implemented on a cloud to serve various industries such as medical, financial, multimedia, transportation, logistics, or etc.

Generally, the network over which the present invention is implemented comprises a plurality of privately or publicly connected nodes, comprising one or more processor nodes, or servers or clusters of servers and or nodes, that are enabled to exchange information over one or more links. Exemplary networks comprise any one or more of WANs, LANs, PANs, Internet 120, as well as ad hoc networks such as Bluetooth or Extranets. The Internet 120 is a collection of interconnected (public and/or private) networks that are linked together by a set of standard protocols to form a global, distributed network. A node comprises one or more processor units (software or hardware, or virtual nodes) and/or devices located anywhere in the network that processes information and/or performs an attributed function. Any node or any component with a node can be virtualized in hardware or software. Different types of nodes can include a receiver node, which received information, a processor node, which processes information, and a transmitter node, which transmits processed information. Examples of nodes include server nodes, client nodes, computer nodes, processor node, communication nodes, work stations, PDAs, mobile devices, entry nodes, exit nodes, user interface nodes, accounting nodes, administration nodes, content delivery nodes, selection nodes, sensor nodes, wired nodes, wireless nodes, and etc.

In one embodiment, the system of the invention comprises one or more servers configured to interface with a plurality of user devices over the network. The plurality of user devices can be one or more first user and one or more second user operating individually or in groups or sub-groups. The nodes of the system can be connected to each other according to any suitable network model, including but not limited to client server models as well as a hierarchical or distribution models. A link comprises any medium over which two nodes may communicate information with each other. Exemplary links include, but are not limited to wired, fiber, cable, or wireless links (e.g., Bluetooth, UWB, USB, etc.). A communication channel comprises any channel used with a link for delivery of content, which can include data obtained from nodes, applications executing in nodes or devices, objects (e.g., vehicles, people), or sensors.

As shown, the client devices are separated into two groups. A first set of client devices includes those that access services using HTTP/WebRTC/SIP protocols (also referred to as WebRTC clients). The second set of client devices includes those that access services using SIP/VoIP protocols (also referred to as SIP/VoIP clients). Examples of WebRTC clients are desktops using a web browser to access content and media generated in a Services layer. WebRTC clients may also be cellphones, smartphones and tablets that run browser applications to access the services. SIP/VoIP clients are defined as devices directly accessing the communication services layer. Examples of SIP/VoIP clients include but are not limited to softphones, desktop phones, mobile phones, tablets and smartphones with a softphone installed.

One type of client devices executes browser applications and another type of client devices executes non-browser applications. As herein described, a web browser application is a telecommunication application that uses HTTP protocol for initiating a session, including transmitting and receiving a first user's authentication information, e.g., user ID and password. A non-browser application is a telecommunication application that uses SIP protocol for initiating a session by transmitting and receiving user authentication information, e.g., user ID and password.

The servers are configured to connect to a client/user device as a WebRTC client that executes a browser application, such as Internet Explorer, Chrome, Firefox, establishes a real-time communication session using WebRTC and accesses a server that is part of the network over Hypertext Transfer Protocol (HTTP). The servers are also configured to connect a client/user device as SIP/VoIP client that executes a non-browser application, such as a softphone app or a desktop phone, establish a real-time communication session using VoIP and access the network using Session Initiation Protocol (SIP). The SIP is used as a communications protocol for signaling and controlling multimedia communication sessions. Signaling uses signals for controlling communication, as well as establishment and control of a telecommunication circuit. It should be pointed out that signaling does not involve user information or media transfer. Media transfer is a separate stage from signaling. Signaling involves sending a signal from a transmitting end of a telecommunication circuit to inform a user at the receiving end that a message/media is to be sent. The servers are configured to authorize the web browser application to access the telecommunication services using HTTP and authorize the non-browser application to access the telecommunication services using SIP.

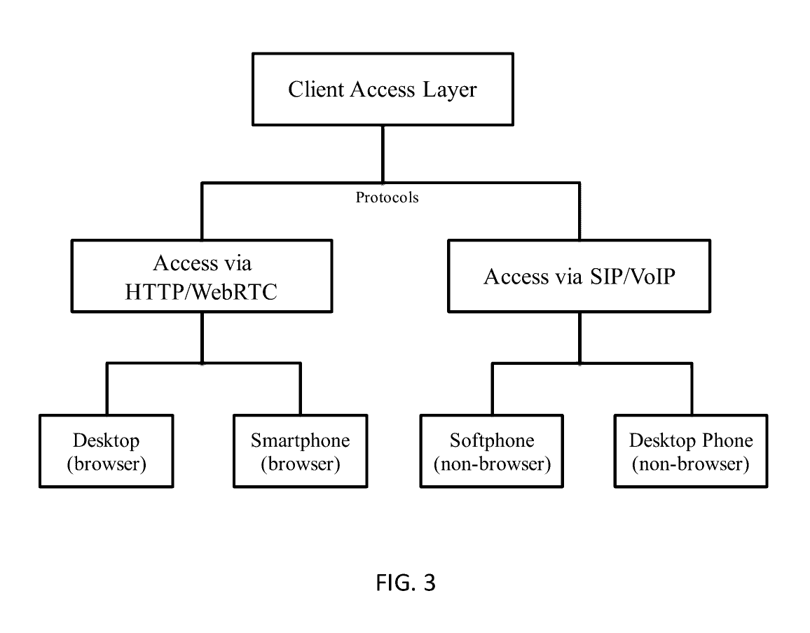

FIG. 3 shows a flow diagram for the Client Access Layer of FIG. 1 where WebRTC desktop or mobile clients running browsers applications are given access authorization via HTTP protocol and VoIP softphone or desktop phone clients running non-browser applications are given access authorization via SIP protocol. In this way, the telecommunication network according to the invention uses the WebRTC for service integration over the web via HTTP/WebRTC protocol for WebRTC clients, thereby replacing traditional methods of communication services and avoiding software downloads, licensing, and reducing costs, while at the same time enabling support for telecommunication services via SIP/VoIP protocol for SIP/VoIP clients over a unified platform. By offering services over WebRTC and SIP/VoIP, the network allows users to interact with chat, video calls, audio and videoconferences, SMS and email simultaneously over the web and mobile apps. The network connects all users globally with a single service and avoiding the need to jump from one app to another.

In one embodiment, Web Socket protocol enables two-way real-time communication access between clients and servers in web-based applications. Web Socket can be used as a sub-protocol for transport mechanism between SIP entities to enable use of SIP in web-oriented deployments. SIP over Websocket is another communication protocol that WebRTC clients can use with a web browser to make phone calls through access to the service and communication layer. SIP is also used when accessing all conference features to enable the platform's “one-to-one” and “one-to-many” videoconferences.

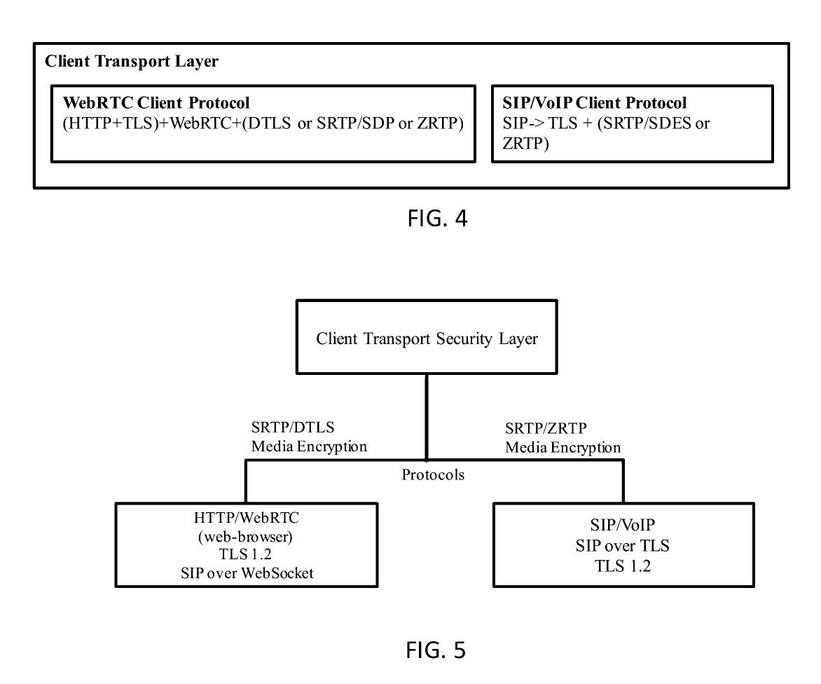

FIG. 4 shows a block diagram of the Client Transport Security Layer. The transport security layer is defined by a set of communications protocols, which are used by clients to access the services and communication layers. The transport security layer is separated into two main sets of protocols one for WebRTC clients and another for SIP/VoIP clients. For different clients, the layer will provide each client with a best-effort selection of protocols and features to serve them. Each client provides its supported features/capabilities when first connecting to the network. Upon presenting capabilities, the transport layer will choose the best selection weighing security, speed and capabilities.

FIG. 5 shows a flow diagram of the Client Transport Security Layer. WebRTC clients that use HTTP as communication layer with browsers can use Transport Layer Security (TLS) cryptography suite for signaling stage. TLS is a protocol that ensures privacy between communicating applications and their users on the Internet. When using WebRTC, there is an additional layer beyond signaling that encrypts all media involved in a conversation at the conversation stage, which is separate from the signaling stage. Encryption algorithms used for media in conversation stage include: a) Secure Real-time Transport Protocol (or SRTP), which defines a profile of RTP (Real-time Transport Protocol), intended to provide encryption, message authentication and integrity, and replay protection to the RTP data in both unicast and multicast applications; b) Datagram Transport Layer Security (DTLS) communications protocol, which provides communications security for datagram protocols; c) SDES (Session Description Protocol Security Descriptions) for Media Streams, which involves negotiating the key for SRTP; and d) ZRTP (composed of Z and Real-time Transport Protocol), which is a cryptographic key-agreement protocol to negotiate the keys for encryption between two end points in a Voice over Internet Protocol (VoIP) phone telephony call based on RTP. These encryption algorithms provide security, encryptions and anonymity during media transfers (i.e., conversations) between clients.

SIP/VoIP clients use TLS encryption, the same as WebRTC clients, when connecting to the communication layer during signaling. This assures the widest range of devices to be served while doing the best effort for securing the signaling, the authentication and the authorization process. Due to the very nature of TLS, the specifics on which protocol will be implemented on each connection are tied to the specific phone maker and version.

For media encryption (as opposed to signaling encryption), the Communication Service Layer uses SDES-SRTP or ZRTP encryption algorithms for SIP/VoIP clients. In one embodiment, the media encryption for SIP/VoIP clients uses a different algorithm than that used for WebRTC clients, which use DTLS-SRTP. The method of media encryption depends directly on client's capabilities. The communication service layer also supports a clear, unencrypted channel with no secure signaling, no secure authentication and no media encryption. This channel is not recommended, but it is provided for compatibility with some devices.

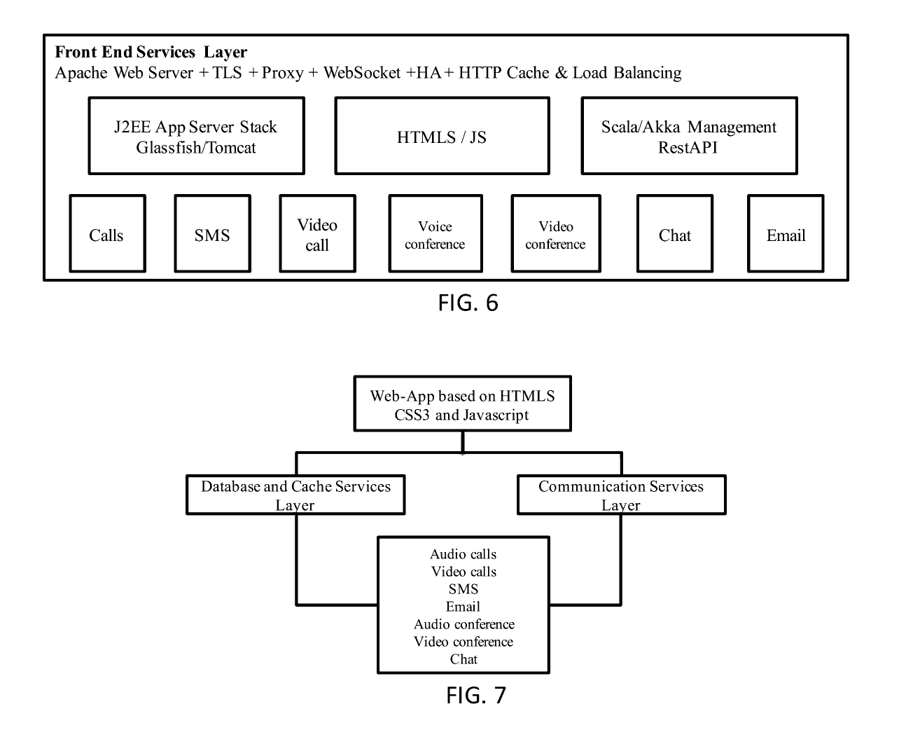

FIG. 6 shows a block diagram of the Frontend Services Layer. The available services are: SIP communications, VoIP communications, carrier class voice services, mobile applications, PBX, Web interface services, contact management, mobile and web Integration, cloud service administration, global SMS platform, email platform, chat service application, Geo-location, screen sharing, call center services, call conference services, video conference services, data management (Web control panel), unified contact management services and social media integration. Online global services can be activated simultaneously around the world. The “cloud” nature of the network allows it to be widely available worldwide. The network can include data centers dispersed around the globe where changes and updates are immediately available to all registered customers. The network is engineered as a distributed, highly available, vertical scalable solution allowing the offered services to grow with demand by simply adding new machines/servers to the cloud.

FIG. 7 shows a flow diagram of the Frontend Services Layer, which provides interaction between services platform and end user through a graphic interface from a web-app based on HTML5, CSS3 and JavaScript. The performance of the Frontend Services Layer depends on the Database & Cache Services Layer and the Communication Services Layer, because each time a service is used, a record is saved in database and service is executed through the corresponding server.

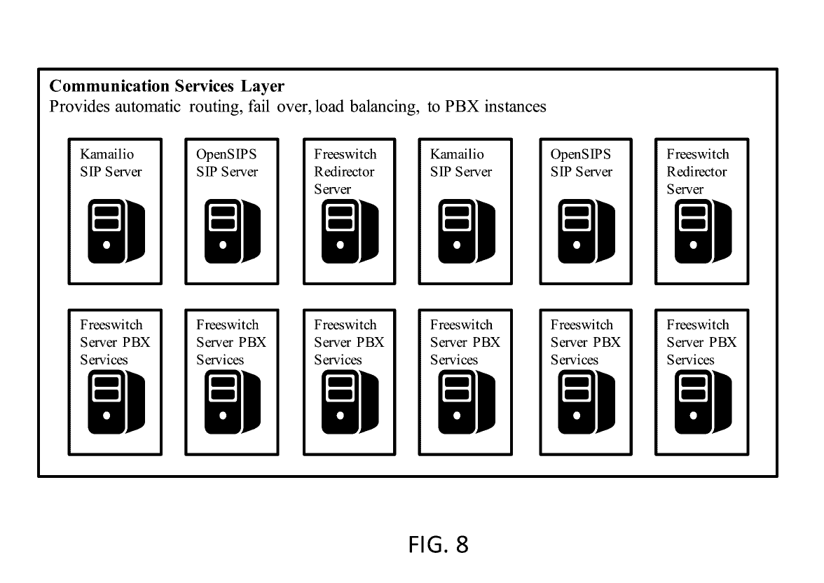

FIG. 8 shows a block diagram of the Communications Services Layer. The Communications Services Layer comprises various server software and dedicated machines that execute the server software to perform all common communication tasks. The servers run a multi-user, multi-threaded, multi-tasking, preemptive capable operating system, such as Linux. Preferably, the Communication Services layer is configured to be fault tolerant with redundant operations with firewall, logging facilities and high availability features.

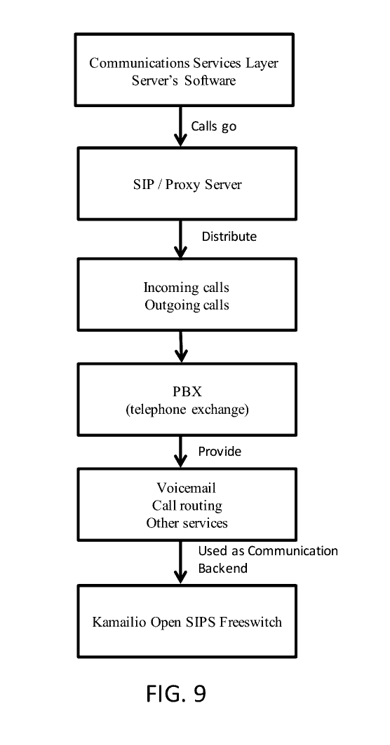

FIG. 9 shows a flow diagram of the Communications Services Layer. All the communications tasks in this layer are performed by server software that runs atop the operating system. One or more servers in charge of communications tasks are SIP Server/SIP Proxy Servers. Another server is based on Private Branch Exchange Phone System, also known as a PBX server. The SIP Servers/SIP Proxy servers perform the following tasks: handling all incoming calls, handling all outgoing calls, redistributing, sending and receiving calls to and from the PBX server software components. The Communications Services Layer relies on a set of concurrently configured PBX server software for the following tasks: provide a layer of communications services such a voicemail, call routing, answering machine, message storing and retrieval, call parking, call forwarding, etc. In one embodiment, the Communications Services Layer is implemented using: kamailio Sip/Proxy Server, openSIPS Sip/Proxy Server, and freeswitch PBX Phone System.

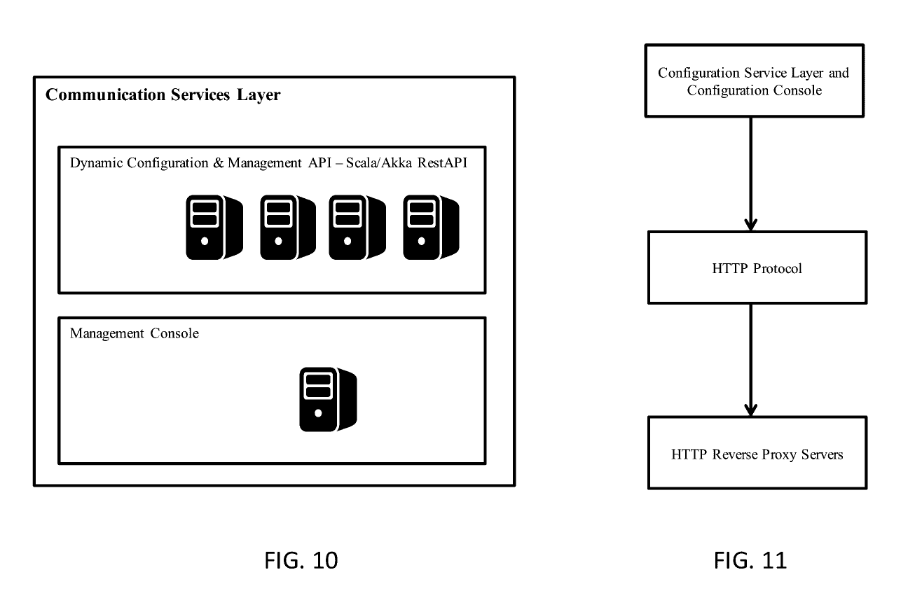

FIG. 10 shows a block diagram of the Configuration Services Layer & Configuration Console. The configuration service layer provides a constant feed for all the information required for operation of the communication service in order to support changes dynamically. The configuration includes information related to operations, routes and intelligent routing information.

FIG. 11 shows a flow diagram of the Configuration Services Layer & Configuration Console. The configuration layer provides a call/response system that the servers in the communication layer use to request information needed to process all aspects of services, for example user/logon authentication details and call routing decisions. Configuration queries/responses are implemented using the HTTP protocol. The configuration layer is a fault tolerant, highly available, distributed service implemented using an arrangement of server software known as HTTP Reverse Proxy servers. The HTTP Reverse Proxy servers take all incoming requests and share them to a set of identical application instances that provide the required answer. Each application instance will receive a request in a round-robin fashion. In one example, the configuration services are implemented in the Scala programming language along with the Akka Concurrency/Reactive model in order to provide scalability, elasticity and fault tolerant environment.

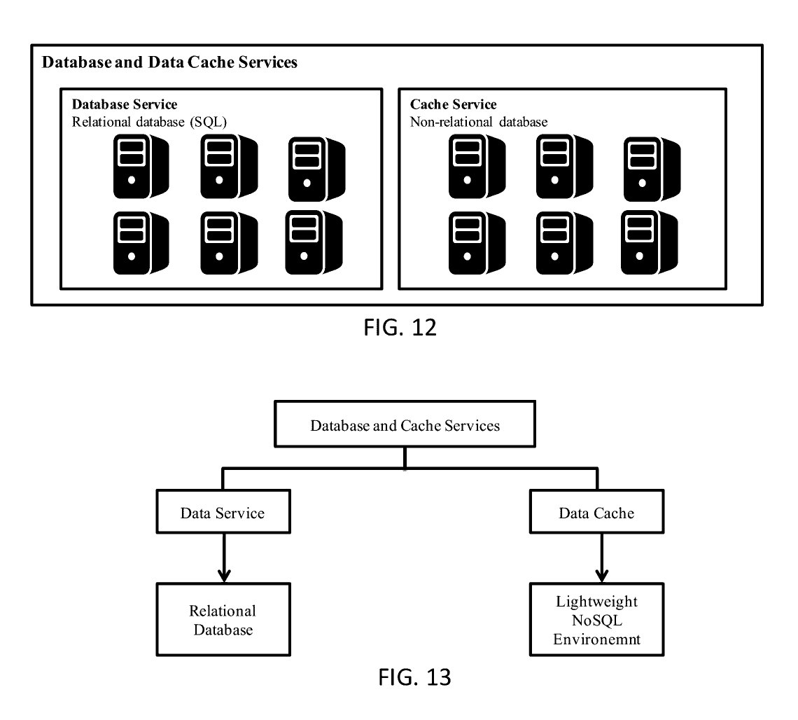

FIG. 12 shows a block diagram of the Database & Cache Services, which comprises two types of database service, namely, a relational database management system (RDBMS) that is based on Structured Query Language (SQL) and a cache storage service that is based on non-relational database management system such as No SQL.

FIG. 13 shows a flow diagram of the Database & Cache Services. The data service uses a full-blown relational database system for permanent, long lasting information storage. The data cache uses a lightweight No SQL environment for quick retrieval/storage of temporal data with an expiration date. The cache is used as a means to offload heavy read and writes from and to the database layer. A server software is used to serve the responses and cache them as needed. When requesting needed data, the configuration services will first determine if the data has been recently cached in the cache storage of the database and cache service. If a cached result is found, it will be used in the response. When no cached response is found in the service, the configuration service will use the data service directly to lookup the right answer. Once found, the configuration service provides answers and serves it as soon as it is available to the communication layer requesting it and will instruct the data service to cache it for a specified period of time. Each required data is first looked upon in a cache service. If not found, it is looked upon in the data service. Each data will be transformed and prepared to be served as a response and will be sent to the cache for future use.

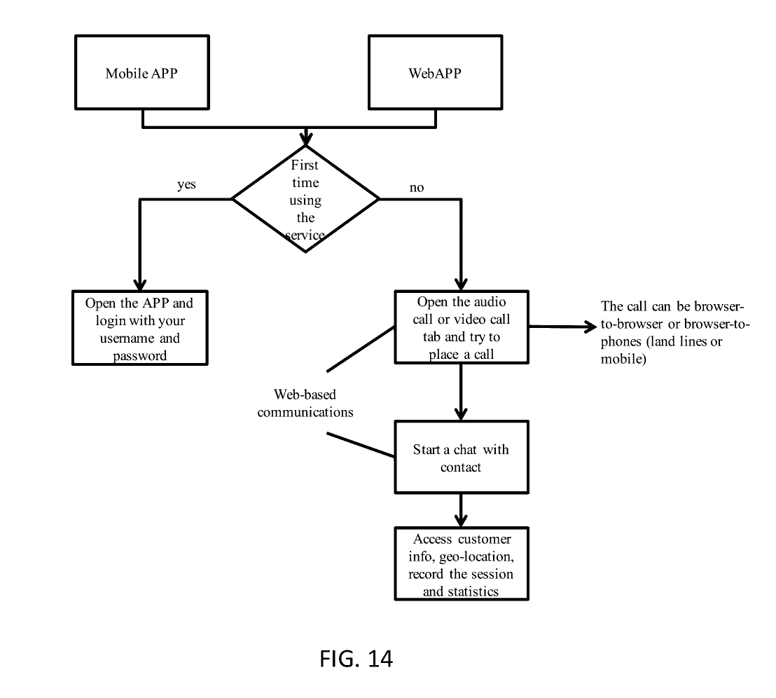

FIG. 14 is a flow diagram of a user making an audio or video call over a web browser app or a non-browser app. First time users of either the web browser app or non-browser mobile phone app login with user and password. Then, such users activate audio or video call interfaces presented to them. The chat is a feature built-in, available using the web browser or the non-browser apps. A chat can be started with user contacts, for example, those in the users contact list. During call sessions, additional services like customer information, geo-location, call recording, and statistics can be used. Once the customer accesses the web or mobile app, the user has the chance to activate audio and video calls. These features are available by accessing a compatible web browser without any additional plugin. This feature is essentially important since the network relies only in the native capabilities of browsers to deliver services. Calls can also be placed from and to a traditional landline phone or cell phone. The network uses WebRTC to leverage direct communication capabilities of browsers. It takes advantage of this communication feature inside browsers to build a wide range of applications. Using the platform to handle all communications, the user is able to use features including information about the caller or destination number, facts about the caller location, features ranging from local weather to a map of the approximate location of the phone call, details and logs from others past calls to the service. The user is also able to save a recording of the current call, and keep a detail log of every call including features ranging from duration of calls to details of the quality of the transmissions. This data could allow potential users to improve their service, find new customers, new markets and forecast new necessities and products.

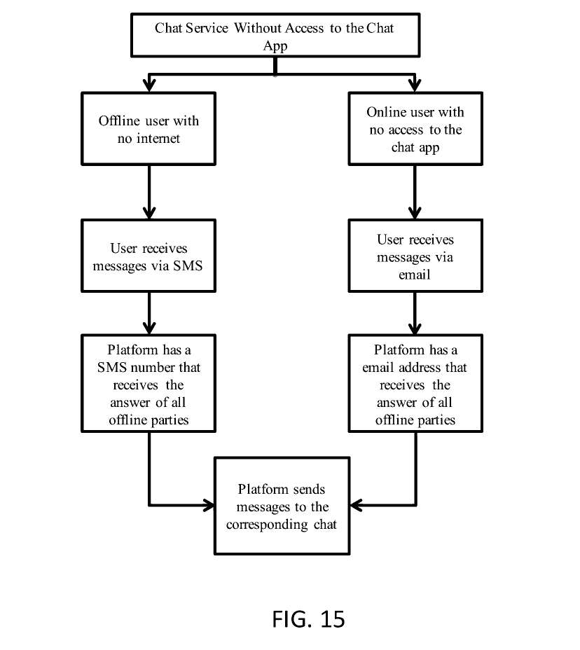

FIG. 15 is a block diagram of chat service according to an aspect of the invention where chat service can be activated and used without an Internet connection by offline users/parties. Alternatively, online users without chat applications can participate in chat messaging. A registered user accesses a browser or non-browser application to send and receive chat messages. Under this embodiment, an offline user without Internet connection receives chat messages originated at a chat application via SMS service. Once a chat session is established, both users can keep the conversation alive even if one of them loses Internet connection. The solutions keep the interaction alive between chat and SMS services through cellular services. Offline users can reply to chat messages originated at a chat session using SMS services. The network uses an SMS number to receive chat messages of all offline users and forwards offline user chat messages to appropriate parties. In this way, the chat service allows an offline user to be part of an active chat via SMS service.

Online users, i.e., users with Internet, can also participate in chat messaging without access to a chat application, i.e., when the chat application is unavailable. If users don't have access to the chat application, they could take part in an active chat conversation via e-mail, receiving and sending messages to the platform using a specific e-mail address that will guarantee interaction between chat users and e-mail users. These users receive chat messages originated at a chat application via e-mail. Online users without the chat application reply to the chat messages via e-mail. The network uses an e-mail address to receive chat messages of online users without the chat application and forwards users chat messages to appropriate parties via e-mail.

The features for participating in the chat service by offline users/parties or online users without access to chat applications can be implemented in registered user profiles. A registered user can enable or disable receiving chat messages in his or her profile without Internet when SMS service is used for communicating chat messages. If enabled in the user profile, the registered user can specify the SMS address/number in his or her user profile for receiving chat messages when offline. Similarly, the registered user can enable or disable receiving chat messages via e-mail when online in his or her user profile. If enabled, the registered user can specify the e-mail address in his or her user profile for receiving chat messages without access to the chat application

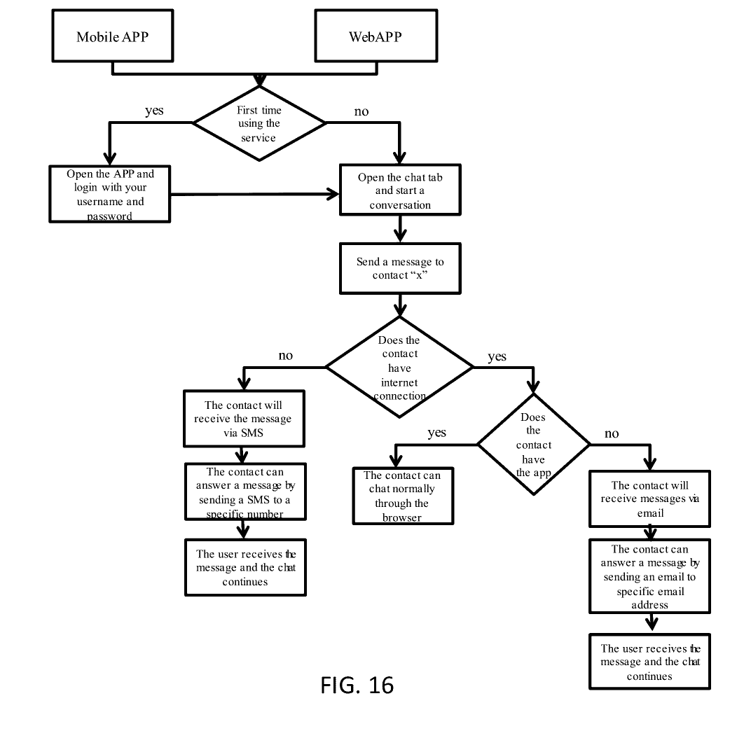

FIG. 16 is a block diagram of a user chat without Internet connection. An offline user takes part of the active chat via SMS services or e-mail. With this configuration, a person with no Internet access could be part of an active chat session without any problem. Once the chat session is established, both users can keep the conversation alive even if one of them loses connection. This solution keeps communication fluid between chat and SMS services. If users do not have access to the chat app, they could take part in an active chat conversation via email, receiving and sending messages to the platform using a specific email address that will guarantee the interaction between chat users and email users.

Whether using a browser or non-browser app, a determination is made based on previous usage of the service. If the service is being used for the first time, the user will open the browser or non-browser app and login with username and password. The user can then proceed to open the chat service and start a conversation by sending a chat message to a contact. If the service has been used before, the user will directly open the chat service and start a conversation. Next, a determination is made based on Internet connectivity of the user. If the user does not have Internet access, the user will use the SMS service to send chat messages. The user can then receive message from a contact at a number specified in the user profile. The contact receiving the offline user's SMS chat messages can receive such messages either via SMS at a number specified in the user profile. The contact can also receive the user's SMS transmitted chat messages in the chat service of the contact's browser or non-browser app depending on settings in the user or contact profile.

If the user has Internet connectivity, i.e., the user is online, a determination is made based on access to the chat service by the user. If the user has access to the chat service, then the user can chat normally through the chat app either from within the browser app or non-browser app. If the user does not have access to the chat app, then the chat messages are transmitted to the contact via e-mail. The user also receives chat messages from contact via e-mail based on address specified in the user profile. The contact receiving the online user's e-mail chat messages can receive such messages via e-mail at an address specified in the user profile. The contact can also receive the user's e-mail transmitted chat messages in the chat service of the contact's browser or non-browser app depending on settings in the user or contact profile. A feature of the chat service is a notification setting in the user profile. When the notification feature is active, the chat messages are forwarded using e-mail or an SMS. When the notifications feature is off, or disabled, the chat messages will be stored in a database for future retrieval.

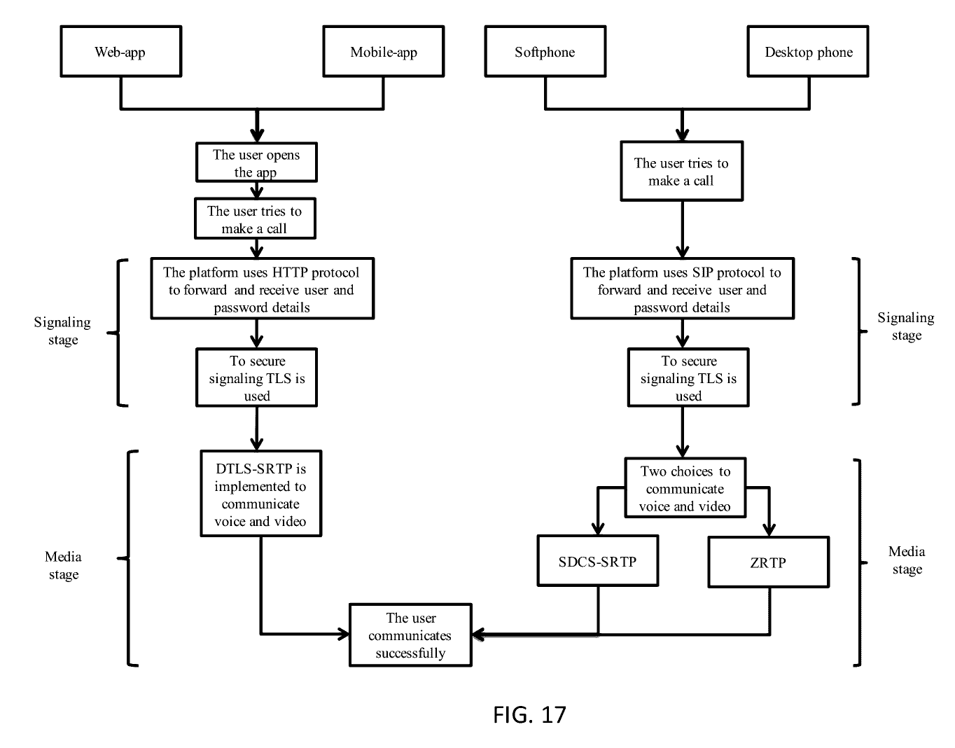

FIG. 17 is a block diagram of encryption and security processes in a call. SIP and WebRTC communications have two distinctive data flow/stages that are secured in order to guarantee a secure service. The first part of these stages the signaling stage of the service. SIP clients use SIP signaling protocol for sending and receiving usernames, passwords and call details necessaries for establishing the communications between endpoints. WebRTC clients will use HTTP protocol for signaling. WebRTC clients transmit and receive users IDs and passwords and the call details of the communications. TLS is used to secure signaling in both types of clients. For media exchange of video, audio, text, graphics, and images in the conversation, different encryption algorithms may be used. When WebRTC clients are involved, DTLS-SRTP encryption is used to communicate voice and video. When SIP/VoIP clients access communication layer, there are two main choices to protect media, SDES-SRTP or the ZRTP encryption. SDES-SRTP implements a key exchange in the attachment section of the SIP protocol (which is supposed to be already secured). These keys are used to share a secret that implements a secure channel between two connected endpoints. The ZRTP implements a key agreements protocol between the endpoints, using Diffie/Hellman key exchange, and SRTP for encryption.

When using a web-app or mobile-app, the user may open the app and try to make a call. During the signaling stage, the platform uses HTTP protocol to forward and receive user and password details and uses TLS for security. Next, during the media stage, DTLS-SRTP is implemented to communicate voice and video. When using a softphone or desktop phone, the user may try to make a call. During the signaling stage, the platform uses SIP protocol to forward and receive user and password details and uses TLS for security. During the media stage, there are two choices to communicate voice and video, SDCS-SRTP and ZRTP, both of which allow the user communicate.

The main advantage of the network described above is delivering a one stop shop solution where the users do not need to be registered, do not need to download any software or use specific hardware to enable all integrated services like under a unified platform. Collaboration, payments, video call records, click to call service using web browser, statistics, contact management, encrypted communications, carrier grade integration, integrated mobile and web interface can be implemented in the network described above. The invention takes traditional services into a new transmission media. Otherwise disperse services can be integrated with state of the art software that provides new alternatives to access through mobile apps, web browsers, and any device available in the market. This new scheme opens new pathways for traditional services to adapt to new technologies making them available for future generations and satisfying longstanding needs. The invention simplifies use for customers and people around the globe. Contrary to the most common apps, the user can enable services with any phone, smartphone, computer or tablet available in the market without limitations. The software integrates in one platform the features that are currently offered through different applications as licensed software or mobile apps. The solution integrates all-in-one WebRTC services using web and mobile interfaces, enabling services simultaneously over both web browser and non-web browser platforms at the same time.

1. A telecommunication network comprising one or more servers configured to:
connect to a first client device associated with a first user, said first client device executing a web browser application to enable the first user to access telecommunication services using a real-time communication protocol, wherein the web browser application comprises a telecommunication application that uses Hypertext Transfer Protocol (HTTP) to transmit and receive the first user's authentication information;
connect a second client device associated with a second user, said second client device executing a non-browser application to enable the second user to access the telecommunication resources using an Internet telephony protocol, wherein the non-browser application comprises a telecommunication application that uses Session Initiation Protocol (SIP) to forward and receive the second user's authentication information;
authorize the web browser application to access the telecommunication services using HTTP;
authorize the non-browser application to access the telecommunication services using SIP;
transport media to the first client device after authorizing access the telecommunication services using HTTP; and
transport media to the second client device after authorizing access the telecommunication services using SIP.

2. The telecommunication network of claim 1, wherein the real-time communication protocol comprises WebRTC protocol.

3. The telecommunication network of claim 1, wherein the WebRTC protocol uses Websocket over SIP.

4. The telecommunication network of claim 1, wherein the Internet telephony protocol comprises VoIP.

5. The telecommunication network of claim 1, wherein the first client device comprises a desktop computer device and the second client comprises a mobile device.

6. The telecommunication network of claim 1, wherein the first client device comprises a mobile device and the second client comprises a desktop phone.

7. The telecommunication network of claim 1, wherein the media transported to the first client is encrypted using a first encryption algorithm, and wherein the media transported to the second client is encrypted using a second encryption algorithm that is different from the first encryption algorithm.

8. The telecommunication network of claim 1, wherein the first and second user's authentication information is encrypted using the same encryption algorithm.

9. The telecommunication network of claim 1, wherein the one or more servers are configured to route calls to the second client device over a software or hardware implemented PBX.

10. The telecommunication network of claim 1, wherein the one or more servers are configured to interface with a configuration console to determine whether a configuration information is cached.

11. The telecommunication network of claim 10, wherein the one or more servers are configured to perform a relational database function when a configuration information is not cached.

12. The telecommunication network of claim 1, wherein an offline user without Internet connection receives chat messages originated at a chat application via an SMS service.

13. The telecommunication network of claim 12, wherein an online user with Internet connection participates in a chat messaging session without a chat application via e-mail.
